(19) United States
(12) Patent Application Publication
(10) Pub. No.: US 2003/0000782 A1
(43) Pub. Date: Jan. 2, 2003

(54) Retarder for exerting a braking action upon a rotating shaft

(76) Inventors: Dean Evan Smith, Thomasville, PA (US); John Keith Smith SR., Dover, PA (US)

Correspondence Address: Bruce J. Wolstoncroft, Esquire, Barley, Snyder, Senft & Cohen, LLC, 126 East King Street, Lancaster, PA, 17602, US

(21) Appl. No.: 09/896,775

(22) Filed: Jun. 29, 2001

(51) Int. Cl. F16D 57/00

(52) U.S. Cl. 188/290

(57) ABSTRACT

The invention is directed to a speed retarding system. The system has a housing with a chamber provided therein. A shaft receiving sleeve extends through the housing and the chamber. A wheel is provided in the chamber and extends from the shaft receiving sleeve to an outer circumferential wall of the housing. The wheel has a plurality of blades provided thereon, the blades extend from the shaft receiving sleeve toward the outer circumferential wall in a generally arcuate configuration. The arcuate configuration of the blades facilitate the pumping action of a liquid which flows through the wheel when the system is in a free moving state and enhances the retardation of movement of the wheel when the system is in a braking state. A ring is provided about an outer circumference of the wheel. The ring is integrally attached to the blades. Whereby as movement of liquid provided in the system is restricted, the relative positioning of blades is maintained by the ring even as heat is accumulated by the system.

### FIELD OF THE INVENTION

The invention relates to a speed retarder which cooperates with a shaft. In particular, the invention is directed to a hydrodynamic braking system.

### BACKGROUND OF THE INVENTION

Service brakes provided on trucks and buses often overheat or fade when the vehicles are subject to extreme conditions, such as long descents. As a consequence, numerous braking systems have been developed to assist braking of these vehicles.

One of the more recognizable systems is referred to as “Jake Brakes” manufactured by the Jacobs Manufacturing Company. As is described in U.S. Pat. No. 4,572,114, the Jacob's brake is a compression release engine retarder which temporarily disables the normal operation of the engine and converts the standard engine into an air compressor for developing a retarding horsepower. This type of engine retarder has several drawbacks. The compression release brake, and similar systems interfaced with the engine, produce a force which is limited by the size and rpm capability of the engine. These brakes can only provide the needed amount of retardation force over long and/or steep grades with the vehicle at a relatively slow speed and with the compression release brake operated at a high engine r.p.m. Once engaged, it is difficult and can be hazardous to shift into a lower gear. Also, if the engine is shut down, the engine retarder does not function.

Another system, the hydraulic retarder, has a larger power capability and is easy to control. However, dissipation of the braking energy is commonly done through the vehicle's own cooling system. This severely limits the retarder performance, complicates the installation, and makes these systems more expensive than the compression release system.

Yet another system, the electrical brake system, though providing a noticeable braking addition, has become unpopular due to cost, weight, fade, and inertia factors, especially on the larger on-highway trucks.

Another vehicle braking system which is not interfaced with the engine is disclosed in Bultmann, U.S. Pat. No. 4,114,734. The Bultmann device has two oppositely rotating and opposing rotors coupled directly to the drive shaft of a vehicle. The Bultmann device requires a separate cooling system to dissipate the heat generated by the rotors. However, the system disclosed is not capable of producing a constant or operator regulated retardant force.

It would, therefore, be advantageous to provide a vehicle retardation system which does not rely on the operation of the engine and which produces a reliable retardant force in any type of conditions.

### SUMMARY OF THE INVENTION

The invention is directed to a speed retarding system. The system has a housing with a chamber provided therein. A shaft receiving sleeve extends through the housing and the chamber. A wheel is provided in the chamber and extends from the shaft receiving sleeve to an outer circumferential wall of the housing. The wheel has a plurality of blades provided thereon, at least some of the blades extend from the shaft receiving sleeve toward the outer circumferential wall in a generally arcuate configuration. The arcuate configuration of the blades facilitate the pumping action of a liquid which flows through the wheel only when the system is in a free moving state and enhances the retardation of movement of the wheel when the system is in a braking state.

A ring is provided about an outer circumference of the wheel. The ring is integrally attached to the blades. Whereby as movement of liquid provided in the system is restricted, the relative positioning of blades is maintained by the ring even as heat is accumulated by the system.

### BRIEF DESCRIPTION OF THE DRAWINGS

FIG. 1 is a perspective view of a speed retarder in accordance with the present invention.

FIG. 2 is a top view of the inside of the speed retarder showing a wheel and blades extending radially from a center shaft.

FIG. 3 is a cross sectional view showing the configuration of a respective blade of the wheel.

FIG. 4 is a cross sectional view showing a control valve and flow control opening.

FIG. 5 is a diagrammatic view representing the gas pedal and its interaction with the control valve and flow control opening.

FIG. 6 is a diagrammatic view showing the system in which the speed retarder is housed.

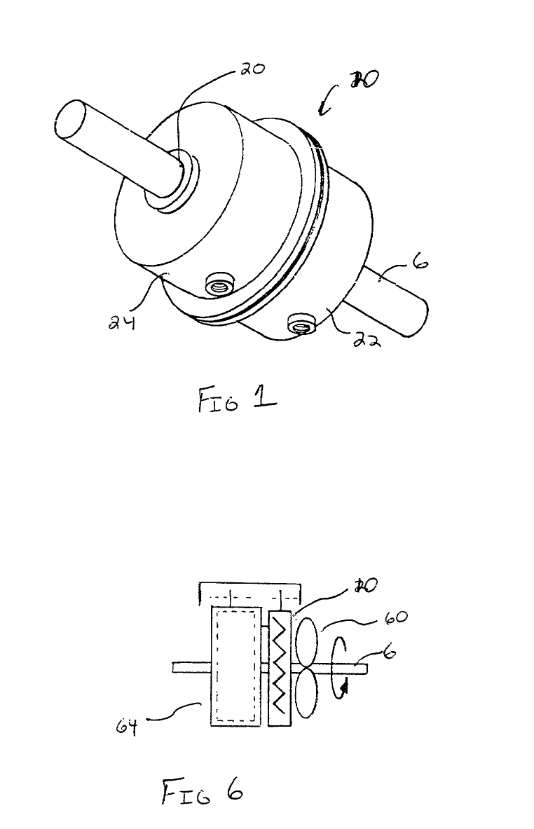

### DETAILED DESCRIPTION OF THE EMBODIMENT

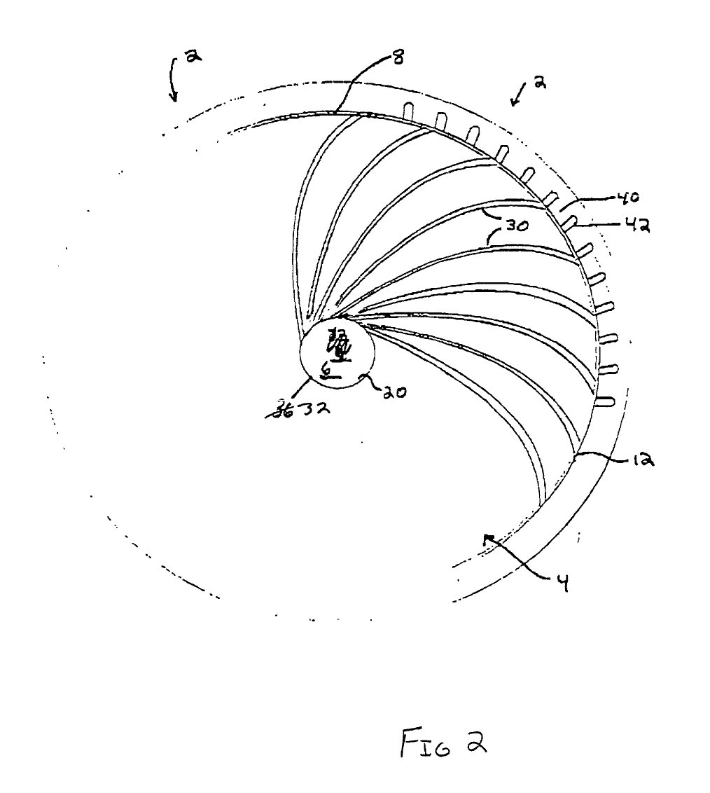

A brake or retarder 2 according to the invention has a rotor wheel 4 coupled to a drive shaft extension 6. The rotor wheel 4 and drive shaft extension 6 are coupled such that rotation of either the rotor wheel or drive shaft will cause the rotation of the other. Referring to FIG. 2, the rotor wheel 4 is provided in a distribution chamber 8 in housing 10. The distribution chamber 8 has a generally circular cross-sectional configuration with an outside wall 12 positioned about the circumference. Passageways or openings 14 extend through the outside wall 12 and connect the distribution chamber 8 to one or more outlet channels 16. An inlet channel 18 also extends into distribution chamber 8.

Housing 10 is made from metal or other material having the desired strength and heat dissipation characteristics required. The exterior surface of the housing may have fins or protrusions which extends therefrom to increase the service area thereof to facilitate in the dissipation of heat. In the embodiment shown, the housing 10 has two halves which are joined and held together by screws or other conventional fastening members. An opening 20 is provided in the housing and is dimensioned to receive the drive shaft extension 6 therein. The opening extends through a first side surface 22 and a second side surface 24 of the housing 10.

Referring to FIG. 2, the rotor wheel 4 has a plurality of blades 30 which extend from proximate an inner drive shaft extension retainer sleeve 32 to a stay ring 34 provided at the outer circumference of the rotor wheel 4. The number of blades 30 may vary according to the application. As shown in the figure, alternating blades extend to and engage the sleeve 32. However various configurations all possible within the scope of the invention, e.g. all blades may extend to and engage the sleeve. In the embodiment shown, the blades 30 are essentially identical in configuration and are uniformly spaced from each other. As shown in FIG. 2, the blades extend radially from the sleeve 32 in an arcuate or curve configuration. The curved configuration of the blades 30 adds to the effectiveness of the retarder 2, as will be more fully described below.

Referring to FIG. 3, the height h_{c} of each blade 30 proximate the center is less than the height hₒ of the blade 30 proximate the outer circumference of the rotor wheel 4. The stay ring 34 is attached to the outer ends 36 of the blades 30. The configuration of the stay ring 34 may vary, but the height hₛ of the stay ring should be minimized so as not to affect the flow of the liquid (as will be more fully described below). As shown in the figure, the configuration of the blades 30 generally conforms to the shape of distribution chamber 8. The blades 30 are dimensioned to be proximate the interior walls of the chamber 8, but are dimensioned to not engage the walls, thereby allowing the rotor wheel 4 to turn freely in the chamber 8.

The outer wall 12 of chamber 8 has cavities 40 provided therein. The cavities 40 are spaced apart and separated by cavity walls 42. The cavities 40 extend essentially the entire height of the outside walls 12. Passageways 14 are periodically positioned in respective cavities 40. The number and dimensions of the cavities 40 may vary according to particular application.

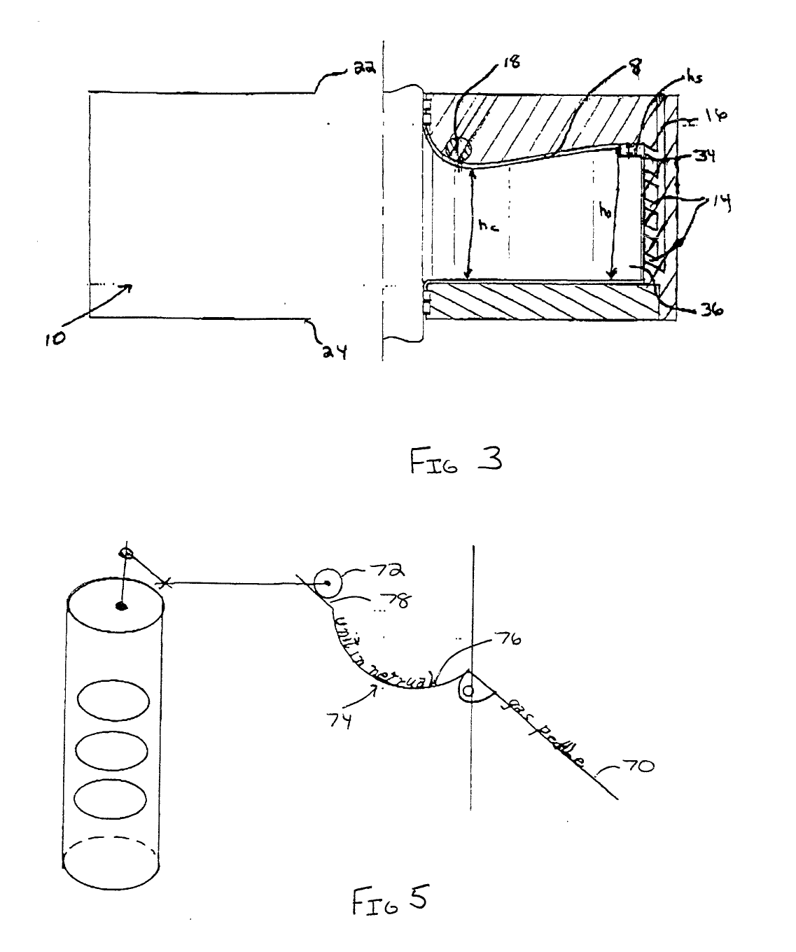

The outlet channels 16 extend through the housing 10 and connect to a distribution system 50 through a flow control opening 51 (FIG. 4) which enables the liquid or oil to be moved within a closed system (as will be more fully discussed). A valve 52 is provided proximate the outlet channels and cooperates with the flow control opening 51 to control the flow of liquid therein.

Referring to FIG. 6, the housing 10 is one component of the retarder 2. Other components include a fan 60 for cooling the liquid and a reservoir 64 for storing and cooling the liquid. A pump may be provided to facilitate the movement of the liquid; however, in most applications, a pump is not required. As the fan 60, pump, and reservoir 64 are conventional parts and as they have been used in prior art hydraulic brakes systems, detailed explanation of these components will not be provided.

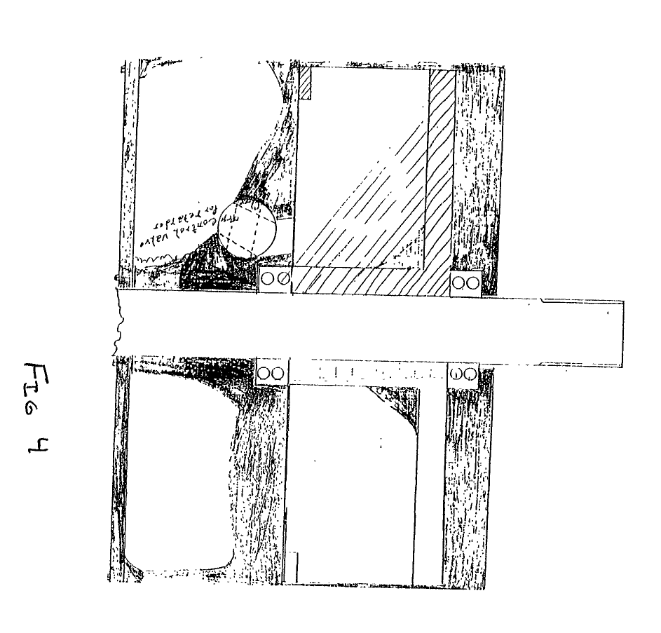

In use, the operator of a truck or other vehicle applies pressure to a gas pedal 70, as shown in FIG. 5, causing the engine to generate the power required to move the vehicle. As the gas pedal is depressed, the valve 52 is moved away from the flow control opening 51, allowing the liquid to move freely within the distribution system 50. The valve 52 is controlled by an actuating lever 72 which cooperates with a cam surface 74, as shown in FIG. 5. When the gas pedal is fully engaged, the actuating lever 72 cooperates with the arcuate surface 76 of the cam surface 74, thereby causing the valve 52 to be moved out of the flow control opening 51. In other words, as the drive shaft is turned, the blades 30 are caused to rotate within the chamber 8. This rotation of the rotor wheel 4 and blades acts as a pump, causing the liquid to be pumped through the inlet channel 18, across blades 30, through cavities 40 and outlet channels 16, and exiting through flow control opening 51 into the system 50. As the valve 52 does not prohibit or inhibit the flow of the liquid, the liquid may move without restriction, such that no opposed force is applied to the rotor wheel. The drive shaft extension 6 and the drive shaft are free to rotate.

In contrast, when the operator desires to slow down, he releases his foot from the gas pedal causing the actuating lever 72 to engage an angled portion 78 of the cam surface 74. The engagement of the actuating lever 72 with the angled portion 78 causes the valve 52 to be moved into the flow control opening 51. The movement of the valve 52 into the opening 51 is known in the art and will not be described in detail. Generally, the movement of the valve into the opening 51 only occurs when the gas pedal is almost completely disengaged. However, the movement of the valve relative to the gas pedal can be controlled to provide the desired results for the application.

With the valve 52 completely positioned in opening 51, the flow of the liquid beyond the valve 52 is prevented. However, as the drive shaft continues to rotate, the blades 30 of the rotor wheel 4 also continue to rotate and continues to act as pump for the liquid. As the liquid is prevented from moving beyond valve 52, the liquid backs up into the outlet channels, the cavities 40, and chamber 8. As this occurs, the reservoir of liquid in the cavities 40 and chamber 8 inhibits the free movement of the blades 30, thereby causing the speed of the rotation of the blades to be slowed. As the blades 30 of the rotor wheel 4 encounter resistance, the rotor wheel is slowed, and so is the drive shaft extension 6 and drive shaft coupled thereto. This results in the braking or retardation of the speed of the vehicle.

While systems with some similarities to that described have been used before, they have proven ineffective, as the systems have not provided the immediate braking forces required or the consistent braking forces required over long distances. The invention described herein does not have the same problems.

The blades 30 of the present invention have an arcuate configuration to allow the middle portion of the blades to act as a suction cup. This allows the flow of liquid to be greatly increased over the conventional straight bladed wheels. This is a significant advantage, as the increased flow of material allows the braking or speed retardation of the drive shaft and vehicle to occur much more quickly. Therefore, the effectiveness of the retarder 2 of the present invention is greatly enhanced. This pumping action is further facilitated by the dimensioning of the blades 30. Each blade is manufactured to have a close tolerance with the inner walls of the chamber 8. The tight dimensions ensure that the flow of liquid will be through the blades, rather than around the blades. No pockets of stagnant liquid will be provided in the chamber when the valve is in the open position, thereby providing optimum pumping capability. Additionally, as all of the blades do not engage the sleeve 32, more liquid will be introduced into the wheel more quickly. Consequently, the pumping action is enhanced and the activation time is reduced adding to the effectiveness and reliability of the retarder.

The shape of the blades 30, with the height h_{c} less than the height hₒ, also contributes to the pumping action. As the liquid enters the chamber 8 through the inlet channel 18, the liquid is moved quickly to the outer circumference of the wheel 4. This movement is facilitated by the configuration of the blades 30.

In addition, the shape of the blades 30 contributes to the braking ability of the system. The blades have greater surface area provided at the outer circumference of the wheel 4 proximate the cavities 40. Therefore, as the fluid backs into the chamber 8, the large surface area at the outer circumference of the wheel 4 will cooperate with the liquid to quickly and effectively slow the wheel 4 and the drive shaft. This effect is increased due to the positioning of the cavities 40. The increased surface area at the outer circumference of the blades 30 causes maximum turbulence with the liquid provided in the cavities 40, thereby enhancing the braking capability of the system.

The stability of the wheel 4 and blades 30 are important to the reliability of the system as the speed retardation occurs. As the liquid backs up into the chamber and as the movement of the wheel and shaft are retarded, significant heat builds up in the fluid and wheel. In the prior art, heat causes the positional stability of the blades to degrade. Consequently, as the heat builds, the blades move relative to each other causing the effectiveness and reliability of the retarder to diminish. In contrast, the present invention maintains the positional stability of the blades during all conditions. The use of the stay ring 34 insures that the blades 30 will be maintained in position. As the stay ring is integrally attached to the blades at the outer circumference, each individual blade cannot move relative to the other blades in extreme conditions. Therefore, as the liquid and components are heated, the reliability and effectiveness of the retarder is not degraded.

As discussed above, the stay ring 34 is positioned to maintain the integrity of the wheel 4. However, as the liquid must freely flow through the blades 30 when the valve 52 is in the open position, the dimensions of the stay ring 34 must be minimized so that the ring does not act as a restriction which slows the flow of the liquid. In particular, the height of the stay ring must be minimized. Therefore, while various configurations of the stay ring are possible, the height of the stay ring must be properly controlled.

The use of the retarder or brake has been described with reference to a truck having significant weight. However, the system described herein can be used for any vehicle having a drive shaft. In addition, this retarder can also be used as a safety device for elevators and the like. The retarder can be attached to the shaft of the elevator so that in the case of a failure, the retarder will slow and control the fall of the elevator, reducing the chance of significant injury. As the retarder of the present invention does not require the use of a functioning motor to perform, the use of the retarder can be used in many additional applications.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A speed retarding system comprising:
a housing having a chamber provided therein;
a shaft receiving sleeve extending through the housing and the chamber;
a wheel provided in the chamber, extending from the shaft receiving sleeve to an outer circumferential wall of the housing;
the wheel having a plurality of blades provided thereon, the blades extend from proximate the shaft receiving sleeve toward the outer circumferential wall in an arcuate configuration;
whereby the arcuate configuration of the blades facilitate the pumping action of a liquid which flows through the wheel when the system is in a free moving state and enhances the retardation of movement of the wheel when the system is in a braking state.

2. The speed retarding system as recited in claim 1 wherein an inlet channel is positioned proximate the shaft receiving sleeve, the inlet channel extends through the housing and provides a passage to allow the liquid to enter the chamber of the housing.

3. The speed retarding system as recited in claim 1 wherein an outlet channel extends through the outer circumferential wall and through the housing to provide a passage for the liquid to flow out of the chamber.

4. The speed retarding system as recited in claim 1 wherein a plurality of cavities are positioned about the outer circumferential wall and extend essentially the entire height of the outer circumferential wall.

5. The speed retarding system as recited in claim 3 wherein a flow control opening cooperates with the outlet channel to control the flow of the liquid in the chamber.

6. The speed retarding system as recited in claim 5 wherein a valve cooperates with the flow control opening such that when the valve is in an open position, the liquid will flow through the chamber, and when the valve is in a closed position, the liquid will be accumulated in the chamber thereby causing the liquid to retard the movement of the blades, which in turn causes a drive shaft attached to the shaft receiving sleeve to be slowed.

7. The speed retarding system as recited in claim 1 wherein a ring is positioned at an outer circumference of the wheel, the ring is attached to the outer ends of the blades to insure that the positional stability of the blades is maintained.

8. The speed retarding system as recited in claim 7 wherein height of ring is minimized to prevent the ring from interfering with the flow of liquid through the chamber.

9. The speed retarding system as recited in claim 1 wherein height of the blades proximate the shaft receiving sleeve is less than the height of the blades proximate the outer circumferential wall, thereby providing the blades with a greater surface area proximate the outer circumferential wall to cause a maximum turbulence with the liquid.

10. The speed retarding system as recited in claim 1 wherein a pluality of the blades engage the shaft receiving sleeve and an alternate plurality of blades are spaced from the shaft receiving sleeve.

11. The speed retarding system as recited in claim 10 wherein alternate blades engage the shaft receiving sleeve.

12. A speed retarding system comprising:
a housing having a chamber provided therein;
a shaft receiving sleeve extending through the housing and the chamber;
a wheel provided in the chamber, extending from the shaft receiving sleeve to an outer circumferential wall of the housing;
the wheel having a plurality of blades provided thereon, the blades extend from the shaft receiving sleeve toward the outer circumferential wall;
a ring provided about an outer circumference of the wheel, the ring being integrally attached to the blades;
whereby as movement of liquid provided in the system is restricted, the relative positioning of blades is maintained by the ring even as heat is accumulated by the system.

13. The speed retarding system as recited in claim 12 wherein at least one opening is provided in the outer circumferential wall which connects to an outlet channel which extends through the housing to provide a passage for the liquid to flow out of the chamber.

14. The speed retarding system as recited in claim 12 wherein an inlet channel is positioned proximate the shaft receiving sleeve, the inlet channel extends through the housing and provides a passage to allow the liquid to enter the chamber of the housing.

15. The speed retarding system as recited in claim 13 wherein a flow control opening cooperates with the outlet channel to control the flow of the liquid in the chamber.

16. The speed retarding system as recited in claim 15 wherein a valve cooperates with the flow control opening such that when the valve is in an open position, the liquid will flow through the chamber, and when the valve is in a closed position, the liquid will be accumulated in the chamber thereby causing the liquid to retard the movement of the blades, which in turn causes a drive shaft attached to the shaft receiving sleeve to be slowed.

17. The speed retarding system as recited in claim 12 wherein the blades have an arcuate configuration allowing a middle portion of each blade to draw the liquid into the chamber at a increased flow rate.

18. The speed retarding system as recited in claim 17 wherein height of the blades proximate the shaft receiving sleeve is less than the height of the blades proximate the outer circumferential wall, thereby providing the blades with a greater surface area proximate the outer circumferential wall to cause a maximum turbulence with the liquid.

19. The speed retarding system as recited in claim 12 wherein height of ring is minimized to prevent the ring from interfering with the flow of liquid through the chamber.

20. The speed retarding system as recited in claim 16 wherein a plurality of cavities are positioned about the outer circumferential wall and extend essentially the entire height of the outer circumferential wall, the cavities are provided to increase the turbulence of the liquid in the chamber when the valve is closed to more quickly slow the rotation of the wheel.

21. A braking system comprising:
a housing having a chamber provided therein;
a shaft receiving sleeve extending through the housing and the chamber;
a wheel provided in the chamber, extending from the shaft receiving sleeve to an outer circumferential wall of the housing;
the wheel having a plurality of blades provided thereon, the blades extend from the shaft receiving sleeve toward the outer circumferential wall in an arcuate configuration;
a ring provided about an outer circumference of the wheel, the ring being integrally attached to the blades;
whereby the configuration of the blades and the ring provide a reliable and quick braking system within operating temperatures.

22. The braking system as recited in claim 21 wherein at least one opening is provided in the outer circumferential wall which connects to an outlet channel which extends through the housing to provide a passage for the liquid to flow out of the chamber.

23. The braking system as recited in claim 21 wherein an inlet channel is positioned proximate the shaft receiving sleeve, the inlet channel extends through the housing and provides a passage to allow the liquid to enter the chamber of the housing.

24. The braking system as recited in claim 21 wherein a flow control opening cooperates with the outlet channel to control the flow of the liquid in the chamber.

25. The braking system as recited in claim 24 wherein a valve cooperates with the flow control opening such that when the valve is in an open position, the liquid will flow through the chamber, and when the valve is in a closed position, the liquid will be accumulated in the chamber thereby causing the liquid to retard the movement of the blades, which in turn causes a drive shaft attached to the shaft receiving sleeve to be slowed.

26. The braking system as recited in claim 25 wherein height of the blades proximate the shaft receiving sleeve is less than the height of the blades proximate the outer circumferential wall, thereby providing the blades with a greater surface area proximate the outer circumferential wall to cause a maximum turbulence with the liquid.

27. The braking system as recited in claim 21 wherein height of ring is minimized to prevent the ring from interfering with the flow of liquid through the chamber.

28. The braking system as recited in claim 26 wherein a plurality of cavities are positioned about the outer circumferential wall and extend essentially the entire height of the outer circumferential wall, the cavities are provided to increase the turbulence of the liquid in the chamber when the valve is closed to more quickly slow the rotation of the wheel.
